(19) United States
(12) Patent Application Publication
(10) Pub. No.: US 2010/0149468 A1
(43) Pub. Date: Jun. 17, 2010

(54) LIQUID CRYSTAL DISPLAY DEVICE

(76) Inventors: Keiichi Ina, Mie (JP); Keisuke Yoshida, Mie (JP)

Correspondence Address: NIXON & VANDERHYE, PC, 901 NORTH GLEBE ROAD, 11TH FLOOR, ARLINGTON, VA, 22203, US

(21) Appl. No.: 12/159,482

(22) PCT Filed: Jul. 7, 2006
(86) PCT No.: PCT/JP2006/313606

§ 371 Date: Jun. 27, 2008

(30) Foreign Application Priority Data
Dec. 28, 2005 (JP) 2005-379170

(51) Int. Cl. G02F 1/1335

(52) U.S. Cl. 349/114

(57) ABSTRACT

A liquid crystal display device (10) includes a TFT substrate (11), a CF substrate (12), and a liquid crystal layer (13) interposed therebetween. The liquid crystal layer (13) is made of a liquid crystal material having negative dielectric anisotropy. When no voltage is applied, liquid crystal molecules of the liquid crystal material are oriented substantially vertical to the TFT substrate (11) and the CF substrate (12). A display region of a liquid crystal display panel (14) is formed by a plurality of pixels. Each of the plurality of pixels includes a light reflection display portion (130) and a light transmission display portion (131). Orientation control means (120) for axisymmetrically orienting the liquid crystal molecules when a voltage is applied to the liquid crystal layer (13) is provided in the light reflection display portion (130).

### TECHNICAL FIELD

The invention relates to a liquid crystal display device.

### BACKGROUND ART

In recent years, liquid crystal display devices have been rapidly applied to communication equipments and also to common electrical equipments. Especially for portable liquid crystal display devices, reflective liquid crystal display devices that do not require a backlight have been used in order to suppress power consumption. However, since the reflective liquid crystal display devices use external light as their light source, the display is hard to see in a dark room or the like. In view of this problem, transflective liquid crystal display devices having both transmissive and reflective properties have been researched and developed in recent years.

A transflective liquid crystal display device has a transmissive portion and a reflective portion in each pixel. In a dark place, the transflective liquid crystal display device turns on a backlight and displays an image by using the transmissive portion of each pixel region. In a bright place, the transflective liquid crystal display device displays an image by using external light in the reflective portion without turning on the backlight. Therefore, the backlight does not need to be turned on all the time, which is advantageous in terms of suppression of power consumption.

With increase in the amount of information to be processed by a main unit of the liquid crystal display devices, the liquid crystal display devices have been required to display more information, and a market demand for higher contrast and a wider viewing angle has been increasing.

In recent years, a vertical alignment mode using a vertical alignment type liquid crystal layer has attracted attention as a display mode of a transflective liquid crystal display device capable of realizing higher contrast and a wider viewing angle. The vertical alignment type liquid crystal layer is generally formed by a vertical alignment film and a liquid crystal material having negative dielectric anisotropy

As an example of such a liquid crystal display device, Patent document 1 discloses a liquid crystal display device including a plurality of pixels having a first electrode on a first substrate, a second electrode on a second substrate, and a liquid crystal layer interposed between the first electrode and the second electrode. The first substrate has a light-shielding region in a gap between the plurality of pixels and has wall structures regularly arranged on the liquid crystal layer side of the light-shielding region. The first electrode has at least one first opening at a predetermined position in the pixel, the second electrode has at least one second opening at a predetermined position in the pixel, and the liquid crystal layer forms at least one liquid crystal domain that provides axisymmetric orientation when at least a predetermined voltage is applied. The central axis of the axisymmetric orientation of at least one liquid crystal domain is formed within or near at least one opening of at least one first opening and at least one second opening. Patent document 1 describes that, with this structure, a liquid crystal display device capable of sufficiently stabilizing liquid crystal orientation and suppressing reduction in contrast ratio or effective aperture ratio can be provided.

Patent document 2 discloses a liquid crystal display device including a first substrate having a first electrode formed thereon, a second substrate having a second electrode formed thereon so as to face the first electrode, and a vertical alignment type liquid crystal layer interposed between the first electrode and the second electrode. A plurality of pixel regions are defined by the first electrode and the second electrode, and at least one of the plurality of pixel regions is divided into a plurality of sub-pixel regions by dielectric structures regularly arranged on the first substrate. When a predetermined voltage is applied between the first electrode and the second electrode, liquid crystal molecules in the liquid crystal layer in the sub-pixel regions are axisymmetrically oriented with respect to an axis vertical to the surface of the first substrate. Patent document 2 describes that, with this structure, a liquid crystal display device capable of sufficiently stabilizing liquid crystal orientation and providing display quality equal to or higher than a conventional example can be provided.

Patent document 1: Japanese Laid-Open Patent Publication No. 2005-172944
Patent document 2: Japanese Laid-Open Patent Publication No. 2005-257809

### DISCLOSURE OF THE INVENTION

### Problems to be Solved by the Invention

FIGS. 12 and 13 show a pixel structure 100 of a conventional vertical alignment mode transflective liquid crystal display device described in Patent document 1 or 2. The pixel structure 100 has a light reflection display portion and a light transmission display portion independently formed within the pixel. Orientation control means 101 is provided in each region in order to control orientation. Therefore, a pixel electrode 102 needs to be divided so that the pixel electrode is provided in each region. In this case, in order to form an electric field gradient for orientation control in each region, an opening having no pixel electrode needs to be provided between the light reflection display portion and the light transmission display portion. The pixel electrode 102 therefore needs to have a narrowed part 103.

However, in the case where the narrowed part 103 of the pixel electrode 102 is provided between the light reflection display portion and the light transmission display portion, the pixel electrode in the region of the narrowed part 103 is thinner than the other regions. Therefore, disconnection may be caused by thermal expansion, thermal contraction and the like during a manufacturing process or during use, resulting in degradation in display quality.

Moreover, an opening is formed by providing the narrowed part 103 in the pixel electrode 102. In other words, a region having no pixel region 102 is formed on both sides of the narrowed part 103. As a result, an ineffective region that does not contribute to display is formed within the display region as shown in FIG. 12, causing reduction in aperture ratio.

Moreover, as shown in FIG. 13, a potential of an underlying wiring 104 in the opening, that is, in the region having no pixel electrode, affects orientation control in the light reflection display portion and the light transmission display portion, which may cause abnormal display.

### Means for Solving the Problems

The invention is made in view of the above problems and it is an object of the invention to provide a liquid crystal display device having an excellent display quality and implementing a high aperture ratio.

A liquid crystal display device according to the invention includes: a first substrate and a second substrate which face each other; and a liquid crystal layer interposed between the first substrate and the second substrate. The liquid crystal layer is made of a liquid crystal material having negative dielectric anisotropy. When no voltage is applied, liquid crystal molecules of the liquid crystal material are oriented substantially vertical to the first substrate and the second substrate, and a display region of a liquid crystal display panel is formed by a plurality of pixels. The liquid crystal display device according to the present invention is characterized in that: each of the plurality of pixels includes a light reflection display portion for providing display by reflecting light from a display surface side and a light transmission display portion surrounding the light reflection display portion for providing display by transmitting light from a back side surface; and orientation control means for axisymmetrically orienting the liquid crystal molecules of the liquid crystal layer when a voltage is applied to the liquid crystal layer is provided in the light reflection display portion.

FIGS. 14 and 15 schematically show a structure 110 of a display portion of the liquid crystal display device according to the invention. In this structure, each of the plurality of pixels of the liquid crystal display panel has the light reflection display portion and the light transmission display portion surrounding the light reflection display portion. Therefore, the pixel electrode 112 does not have a narrowed part for providing an opening. Since there is no thinned region in the pixel electrode 112, disconnection that is conventionally caused in this region does not occur, whereby degradation in display quality can be avoided.

Moreover, it is not necessary to form an opening by providing a narrowed part in the pixel region 112. Therefore, an ineffective region that does not contribute to display is not produced in the display region. As a result, reduction in aperture ratio can be avoided.

Moreover, since the display region does not have any ineffective region where there is no pixel electrode 112, display is not affected by a potential of an underlying wiring 114, and abnormal display does not occur.

In the liquid crystal display device according to the invention, the light reflection display portion may be formed in a center of the light transmission display portion.

In this structure, since the light reflection display portion is formed in the center of the light transmission display portion, balanced orientation can be obtained in the entire pixel when liquid crystal molecules are oriented radially from the orientation control means, as shown in FIG. 15. Therefore, display quality is further improved.

In the liquid crystal display device according to the invention, the light reflection display portion and the light transmission display portion may have a similar outer shape.

In this structure, since the outer shape of the light reflection display portion is similar to that of the light transmission display portion, balanced orientation can be obtained in the entire pixel when liquid crystal molecules are oriented radially from the orientation control means. Therefore, display quality is improved.

In the liquid crystal display device according to the invention, the light reflection display portion and the light transmission display portion may have a square outer shape.

In this structure, since the light reflection display portion and the light transmission display portion have a square outer shape, balanced orientation of liquid crystal molecules can be obtained from the center of the light reflection display portion to the end of the light transmission display portion. Therefore, display quality is further improved.

In the liquid crystal display device according to the invention, the orientation control means may be formed in a center of the light reflection display portion.

In this structure, since the orientation control means is formed in the center of the light reflection display portion, balanced radial orientation of liquid crystal molecules can be obtained all over around the center of the display portion. Therefore, display quality is improved.

In the liquid crystal display device according to the invention, the orientation control means may be a protrusion formed in the first substrate or the second substrate.

In this structure, the protrusion can be formed by a normal patterning process or the like. Therefore, the orientation control means can be easily formed by using existing facilities.

In the liquid crystal display device according to the invention, the orientation control means may be a notch formed in the first substrate or the second substrate.

In this structure, the notch can be formed by a normal patterning process or the like. Therefore, the orientation control means can be easily formed by using existing facilities.

In the liquid crystal display device according to the invention, each of the plurality of pixels may have a first electrode of the first substrate and a second electrode of the second substrate, and the notch may be formed in the first electrode or the second electrode.

In this structure, the orientation control means can be formed simultaneously in a patterning process of the pixel electrode. Accordingly, manufacturing cost and manufacturing efficiency are improved.

### Effects of the Invention

As has been described above, according to the invention, a liquid crystal display device having an excellent display quality and implementing a high aperture ratio can be provided.

### BRIEF DESCRIPTION OF THE DRAWINGS

FIG. 1 is a cross-sectional view of a pixel structure of a liquid crystal display device 10 according to a first embodiment;

FIG. 2 is a plan view of a pixel structure of liquid crystal display devices 10 through 80 according to first through eighth embodiments;

FIG. 3 is a plan view of a pixel structure of the liquid crystal display devices 10 through 80 having a horizontally long rectangular display portion 93;

FIG. 4 is a plan view of a pixel structure of the liquid crystal display devices 10 through 80 having a vertically long rectangular display portion 93;

FIG. 5 is a cross-sectional view of a pixel structure of the liquid crystal display device 20 according to the second embodiment;

FIG. 6 is a cross-sectional view of a pixel structure of the liquid crystal display device 30 according to the third embodiment;

FIG. 7 is a cross-sectional view of a pixel structure of the liquid crystal display device 40 according to the fourth embodiment;

FIG. 8 is a cross-sectional view of a pixel structure of the liquid crystal display device 50 according to the fifth embodiment;

FIG. 9 is a cross-sectional view of a pixel structure of the liquid crystal display device 60 according to the sixth embodiment;

FIG. 10 is a cross-sectional view of a pixel structure of the liquid crystal display device 70 according to the seventh embodiment;

FIG. 11 is a cross-sectional view of a pixel structure of the liquid crystal display device 80 according to the eighth embodiment;

FIG. 12 is a schematic diagram of a pixel structure 100 of a conventional vertical alignment mode transflective liquid crystal display device;

FIG. 13 is a schematic diagram illustrating influences of an underlying wiring 104 on the conventional vertical alignment mode transflective liquid crystal display device;

FIG. 14 is a schematic diagram of a structure 110 of a display portion of a liquid crystal display device according to the invention; and

FIG. 15 is a schematic diagram illustrating influences of an underlying wiring 114 on the liquid crystal display device of the invention.

### DESCRIPTION OF THE REFERENCE NUMERALS

10, 20, 30, 40, 50, 60, 70, 80 liquid crystal display device

11, 41, 51, 61, 81 TFT substrate

12, 22, 32, 42 CF substrate

13 liquid crystal layer

14, 24, 34, 44, 54, 64, 74, 84 liquid crystal display panel

15, 96 insulating substrate

16 reflective film

17 transparent insulating layer

18 pixel electrode

98 transparent insulating layer

63, 83, 120 protrusion

25, 35, 45, 55 notch

93 display portion

97 CF layer

98 transparent dielectric layer

99 counter electrode

130 light reflection display portion

131 light transmission display portion

### BEST MODE FOR CARRYING OUT THE INVENTION

Hereinafter, liquid crystal display devices according to first through eighth embodiments of the invention will be described in detail with reference to the figures. It should be understood that the invention is not limited to the following embodiments. The liquid crystal display devices according to the first through eighth embodiments are transflective liquid crystal display devices capable of providing both transmission mode display and reflection mode display. In each pixel, a portion for providing display by reflecting light from the display surface side is herein referred to as a light reflection display portion, and a portion surrounding the light reflection display portion for providing display by transmitting light from the back surface side is herein referred to as a light transmission display portion.

### First Embodiment

(Structure of a Liquid Crystal Display Device 10)

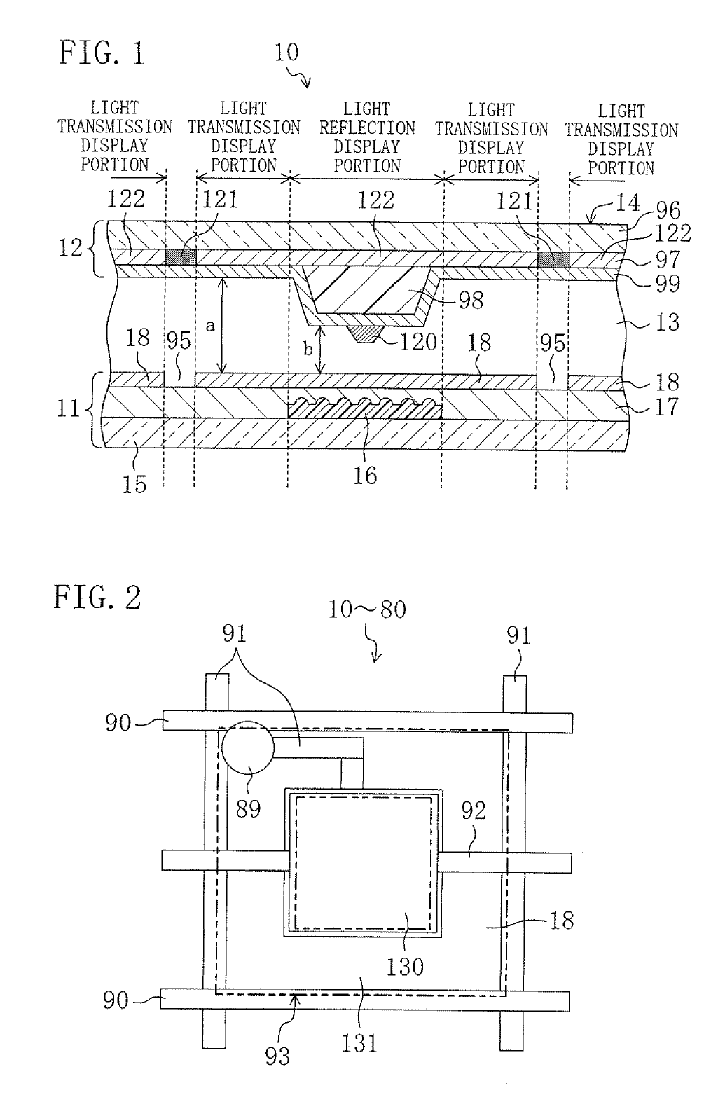

FIG. 1 is a cross-sectional view of a pixel structure of a liquid crystal display device 10 according to a first embodiment. FIG. 2 is a plan view of a pixel structure of the liquid crystal display device 10.

The liquid crystal display device 10 is formed by: a liquid crystal display panel 14 having a thin film transistor substrate (TFT substrate 11) and a color filter substrate (CF substrate 12) which face each other, and a liquid crystal layer 13 interposed therebetween; a not-shown backlight; and the like.

The TFT substrate 11 is formed by an insulating substrate 15, circuit elements formed on a surface of the insulating substrate 15, a reflective film 16 formed on the insulating substrate 15, a transparent insulating layer 17 formed so as to cover the reflective film 16, a pixel electrode 18 provided on the transparent insulating layer 17, and a not-shown vertical alignment film formed on the pixel electrode 18.

Thin film transistors 89 each formed by not-shown gate, source, and drain electrodes and the like are formed on the TFT substrate 11. The gate electrode is connected to a scanning line 90, the drain electrode is connected to a signal line 91, and the source electrode is connected to the pixel electrode 18. The TFT substrate 11 has a storage capacitor in each pixel electrode 18. The storage capacitor is formed by the pixel electrode 18 and a reference electrode line 92.

The reflective film 16 formed on the insulating substrate 15 has a square shape when viewed two-dimensionally. A light reflection display portion 130 in a display portion 93 is defined by the reflective film 16. Therefore, the light reflection display portion 130 has a square shape in this embodiment. The reflective film 16 is formed by vapor depositing an Al layer or the like on a corrugated resin layer. The reflective film 16 therefore has a corrugated surface. The reflective film 16 is formed in the center of the pixel electrode 18.

The transparent insulating layer 17 is formed so as to cover the reflective film 16 and thus planarizes the corrugated profile of the reflective film 16 at the surface.

The pixel electrode 18 is formed on the flat surface of the transparent insulating layer 17. The pixel electrode 18 is made of ITO (Indium Tin Oxide) or the like and is a transparent electrode. The pixel electrode 18 has a notch 95 formed at a predetermined position. Each pixel is divided into square pixel patterns as shown in FIG. 2 by the notch 95. The display portion 93 is defined by the pixel electrode 18. When a predetermined voltage is applied to the liquid crystal layer 13, a liquid crystal domain that provides radial tilt orientation is formed in each of the plurality of pixel patterns by orientation regulation of an oblique electric field generated around the pixel electrode 18 and near the notch 95.

The CF substrate 12 is formed by an insulating substrate 96 made of glass or the like, a CF layer 97 formed on the insulating substrate 96, a transparent dielectric layer 98 formed on the CF layer 97, a counter electrode 99 formed on the CF layer 97 and the transparent dielectric layer 98, a protrusion 120 (orientation control means) formed on the counter electrode 99, and a not-shown vertical alignment film formed on the counter electrode 99 and the protrusion 120.

The CF layer 97 is formed by pixel patterns of three primary colors: red (R), green (G), and blue (B). A black matrix 121 is formed between the pixel patterns as a frame for obtaining contrast. The pixel patterns are separated from each other by the black matrix 121. Each pixel pattern separated by the black matrix 121 has the same shape as the square pixel electrode 18 on the TFT substrate 11 and is formed right above the pixel electrode 18. In other words, the pixel pattern and the pixel electrode 18 are positioned so as to completely overlap each other when the display portion 93 is viewed two-dimensionally. In addition to the combination of RBG, pixel patterns of complementary colors, i.e., cyan, magenta, and yellow, may be used, and colorless pixel patterns may be used.

The transparent dielectric layer 98 is formed on the light reflection display portion 130 of the CF substrate 12. The transparent dielectric layer 98 has the same shape as the square reflective film 16 on the TFT substrate 11 and is formed right above the reflective film 16. In other words, the transparent dielectric layer 98 and the reflective film 16 are positioned so as to completely overlap each other when the light reflection display portion 130 is viewed two-dimensionally. The transparent dielectric layer 98 has a truncated quadrangular pyramid shape with a predetermined thickness. Preferably, the thickness of the transparent dielectric layer 98 is approximately about one half of the thickness a of the liquid crystal layer 13. In the reflection mode display, light used for display passes through the liquid crystal layer 13 two times. In the transmission mode display, on the other hand, light used for display passes through the liquid crystal layer 13 only once. Accordingly, when the thickness a of the liquid crystal layer 13 in the light transmission display portion 131 is approximately twice the thickness b of the liquid crystal layer 13 in the light reflection display portion 130, the optical path length is the same in the reflection mode display and the transmission mode display. As a result, excellent display can be implemented in both display modes.

The counter electrode 99 is formed on the CF layer 97 and the transparent dielectric layer 98. The counter electrode 99 is made of ITO or the like and is a transparent electrode.

The protrusion 120 is formed on the counter electrode 99 and located in the center of the transparent dielectric layer 98, that is, in the center of the light reflection display portion 130. The material of the protrusion 120 is not specifically limited. The protrusion 120 may be made of a resin material, a ceramic material, or a metal material. The protrusion 120 has a truncated cone shape extending toward the opposing TFT substrate 11 with a gap formed between the top of the truncated cone and the TFT substrate 11. The shape of the protrusion 120 is not limited, and the protrusion 120 may have a cone shape, a pyramid shape, a truncated pyramid shape, or the like.

The liquid crystal layer 13 is provided between the TFT substrate 11 and the CF substrate 12. The liquid crystal layer 13 includes a nematic liquid crystal material having negative dielectric anisotropy, and if necessary, further includes a chiral material. When no voltage is applied, liquid crystal molecules of the liquid crystal material of the liquid crystal layer 13 are oriented substantially vertical to the TFT substrate 11 and the CF substrate 12.

(Manufacturing Method of the Liquid Crystal Display Device 10)

Hereinafter, a method for manufacturing the liquid crystal display device 10 will be described.

(Manufacturing Method of the CF Substrate 12)

First, an insulating substrate 96 is prepared. A black matrix 121 having a width of 5 to 50 μm is then formed by a sputtering method in a region to be a light-shielding portion on the insulating substrate 96. A resin film (dry film) having a red pigment dispersed therein is laminated on the whole surface over a region to be a display portion 93 on the insulating substrate 96. Exposure, development, and baking (heat treatment) are then performed to form a first color layer 122 (red). Thereafter, a resin film having a green pigment dispersed therein is laminated on the whole surface over the first color layer 122. Exposure, development, and baking (heat treatment) are then performed to form a second color layer 122 (green). A third color layer 122 (blue) is formed similarly.

Note that the color layer 122 may have a stripe arrangement or a delta arrangement. Instead of laminating a dry film, the color layer 122 may be formed by applying a photosensitive resin material having a pigment dispersed therein to the whole surface by a spin coating method or a slit coating method. The order of forming each color of the color layer 122 is not specifically limited, and the color layer 122 of each color may be formed in a different order.

A transparent dielectric layer 98 is then formed in a region to be a light reflection display portion 130 on the color layer 122.

ITO is then vapor deposited on the color layer 122, the black matrix 121, and the transparent dielectric layer 98 to form a counter electrode 99.

Thereafter, a protrusion 120 is formed in the center of the transparent dielectric layer 98 on the counter electrode 99. The protrusion 120 is formed by a photolithography method.

A vertical alignment film is then formed on the counter electrode 99.

The CF substrate 12 is completed by the above process.

(Manufacturing Process of the TFT substrate 11)

Thereafter, an insulating substrate 15 is prepared, and a gate electrode made of Ta or Al/Ti is formed by a sputtering method and patterned. SiNx is then formed as a gate insulating film and a semiconductor a-Si is formed as a thin film. SiNx is then formed as an etching protection film, and patterning is conducted. Note that a thin film transistor may be made of P—Si or single-crystal Si, and the transistor structure may be a top gate structure. A contact hole, a drain electrode, and a source electrode are then formed. In the same process or a separate process, a driver is provided at a substrate end, whereby a thin film transistor 89 is formed. A reflective film 16 is formed in a region to be a light reflection display portion 130, and patterning is conducted. A transparent insulating layer 17 is then formed thereon. Thereafter, ITO is vacuum deposited and patterning is conducted, whereby a pixel electrode 18 having a predetermined notch 95 is formed. The pixel electrode 18 is formed in a region to be a display portion 93. Thereafter, a plurality of pillar-shaped spacers (not shown) for defining the cell thickness are formed at predetermined positions outside the display portion 93 by a photolithography process. Note that the pillar-shaped spacers may be formed on the CF side or may be formed at predetermined positions within the display portion 93. Alternatively, a method of dispersing spherical spacers may be used.

(Process of Forming the Liquid Crystal Display Panel 14)

Thereafter, a liquid crystal material is dropped on the TFT substrate 11, for example, 2 mg per shot, by a dispenser or the like. At this time, the liquid crystal material is dropped inside of a sealant applied in a frame shape around the outer periphery of a light-shielding region of the TFT substrate 11. Thereafter, the CF substrate 12 is aligned with the TFT substrate 11 having the liquid crystal material dropped thereon, and attached to the TFT substrate 11. This process is performed under vacuum. When returned to the atmosphere, the liquid crystal material between the TFT substrate 11 and the CF substrate 12 attached to each other is diffused by the atmospheric pressure. Thereafter, the sealant is cured by emitting UV light to the sealant while moving a UV light source along the sealant applied region. The diffused liquid crystal material is thus sealed between the two substrates, whereby a liquid crystal display panel 14 is formed. The liquid crystal display device 10 is completed by providing a not-shown backlight unit and the like to the liquid crystal display panel 14.

The liquid crystal display panel 14 is not necessarily formed in the manner described in this embodiment. A liquid crystal inlet may be formed on a side of the liquid crystal display panel 14. In this case, a liquid crystal material may be injected into the liquid crystal display panel 14 through the liquid crystal inlet, and the liquid crystal inlet may be sealed with an ultraviolet curable resin or the like.

### Second Embodiment

(Structure of a Liquid Crystal Display Device 20)

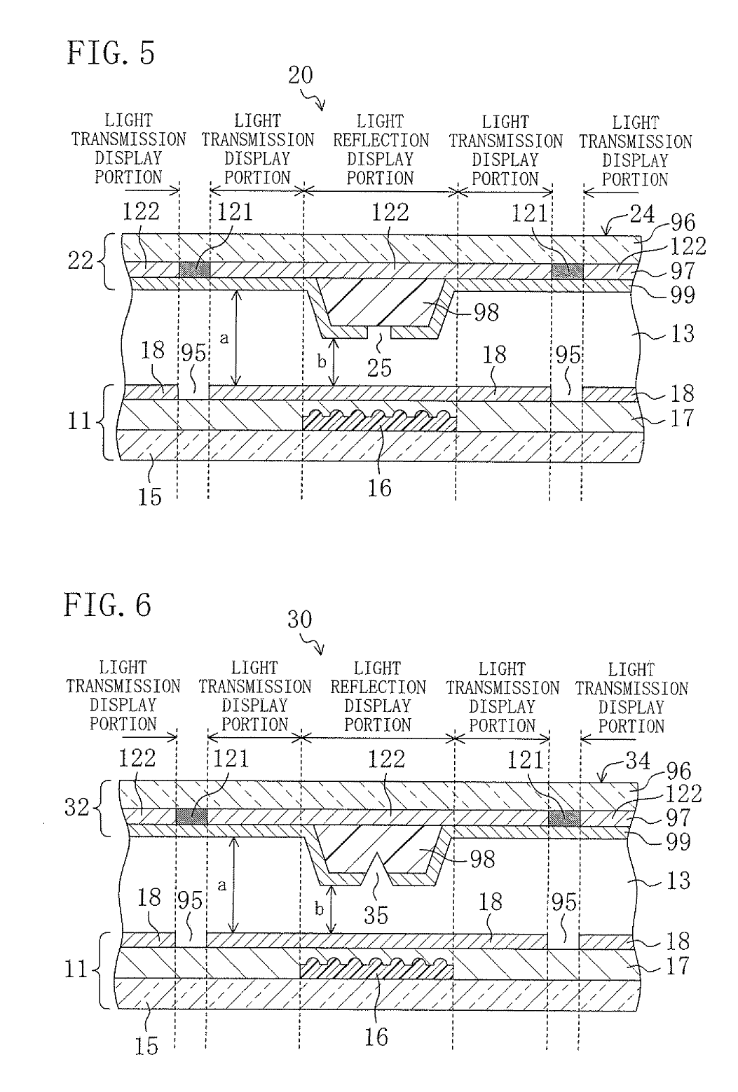

FIG. 5 is a cross-sectional view of a pixel structure of a liquid crystal display device 20 according to a second embodiment. The same portions as those described in the above embodiment are denoted by the same reference numerals and characters description thereof will be omitted.

The liquid crystal display device 20 is formed by: a liquid crystal display panel 24 having a TFT substrate 11 and a CF substrate 22 facing each other, and a liquid crystal layer 13 interposed therebetween; a not-shown backlight; and the like.

The CF substrate 22 is formed by an insulating substrate 96 made of glass or the like, a CF layer 97 formed on the insulating substrate 96, a transparent dielectric layer 98 formed on the CF layer 97, a counter electrode 99 formed on the CF layer 97 and the transparent dielectric layer 98, and a not-shown vertical alignment film formed on the counter electrode 99.

The counter electrode 99 is formed on the CF layer 97 and the transparent dielectric layer 98. The counter electrode 99 has a circular notch 25 (orientation control means) in the center of the transparent dielectric layer 98. The notch 25 need not necessarily have a circular shape, but may have an oval shape or a polygonal shape.

(Manufacturing Method of the Liquid Crystal Display Device 20)

Hereinafter, a method for manufacturing the liquid crystal display device 20 will be described.

(Manufacturing Method of the CF Substrate 22)

First, a color layer 122, a black matrix 121, and a transparent dielectric layer 98 are formed on an insulating substrate 96 in the same manner as in the first embodiment. ITO is then vapor deposited on the transparent dielectric layer 98 to form a counter electrode 99.

Thereafter, the counter electrode 99 is patterned so that a circular notch 25 is located in the center of the transparent dielectric layer 98, and a vertical alignment film is formed on the counter electrode 99. The CF substrate 22 is completed by the above process.

(Manufacturing Process of the TFT Substrate 11)

A TFT substrate 11 is then formed in the same manner as in the first embodiment.

(Process of Forming the Liquid Crystal Display Panel 24)

Thereafter, a liquid crystal display panel 24 having a liquid crystal material sealed between the two substrates is formed in the same manner as in the first embodiment, and a liquid crystal display device 20 is completed by providing a not-shown backlight unit and the like to the liquid crystal display panel 24.

### Third Embodiment

(Structure of a Liquid Crystal Display Device 30)

FIG. 6 shows a liquid crystal display device 30 according to a third embodiment. The same portions as those described in the above embodiments are denoted with the same reference numerals and characters and description thereof will be omitted.

The liquid crystal display device 30 is formed by: a liquid crystal display panel 34 having a TFT substrate 11 and a CF substrate 22 facing each other, and a liquid crystal layer 13 interposed therebetween; a not-shown backlight; and the like.

The CF substrate 22 is formed by an insulating substrate 96 made of glass or the like, a CF layer 97 formed on the insulating substrate 96, a transparent dielectric layer 98 formed on the CF layer 97, a counter electrode 99 formed on the CF layer 97 and the transparent dielectric layer 98, and a not-shown vertical alignment film formed on the counter electrode 99.

The counter electrode 99 is formed on the CF layer 97 and the transparent dielectric layer 98, and the vertical alignment film is formed on the counter electrode 99.

A notch 35 (orientation control means) is formed in the thickness direction in the vertical alignment film, the counter electrode 99, and the transparent dielectric layer 98 formed right under the counter electrode 99 in the CF substrate 32. The notch 35 has a cone shape having its vertex located within the transparent dielectric layer 98 and its base located at the surface of the vertical alignment film. The notch 35 is formed so as to be located on the center of the transparent dielectric layer 98. The notch 35 need not necessarily have a cone shape, but may have a truncated cone shape, a pyramid shape, a truncated pyramid shape, or the like.

(Manufacturing Method of the Liquid Crystal Display Device 30)

Hereinafter, a method for manufacturing the liquid crystal display device 30 will be described.

(Manufacturing Method of the CF Substrate 32)

First, a color layer 122, a black matrix 121, and a transparent dielectric layer 98 are formed on an insulating substrate 96 in the same manner as in the first embodiment. ITO is then vapor deposited on the transparent dielectric layer 98 to form a counter electrode 99. A vertical alignment film is formed on the counter electrode 99. Thereafter, the vertical alignment film, the counter electrode 99, and the transparent dielectric layer 98 are patterned so that a conical notch 35 is located in the center of the transparent dielectric layer 98.

The CF substrate 32 is completed by the above process.

(Manufacturing Process of the TFT Substrate 11)

A TFT substrate 11 is then formed in the same manner as in the first embodiment.

(Process of Forming the Liquid Crystal Display Panel 34)

Thereafter, a liquid crystal display panel 34 having a liquid crystal material sealed between the two substrates is formed in the same manner as in the first embodiment, and a liquid crystal display device 30 is completed by providing a not-shown backlight unit and the like to the liquid crystal display panel 34.

(Fourth Embodiment)

(Structure of a Liquid Crystal Display Device 40)

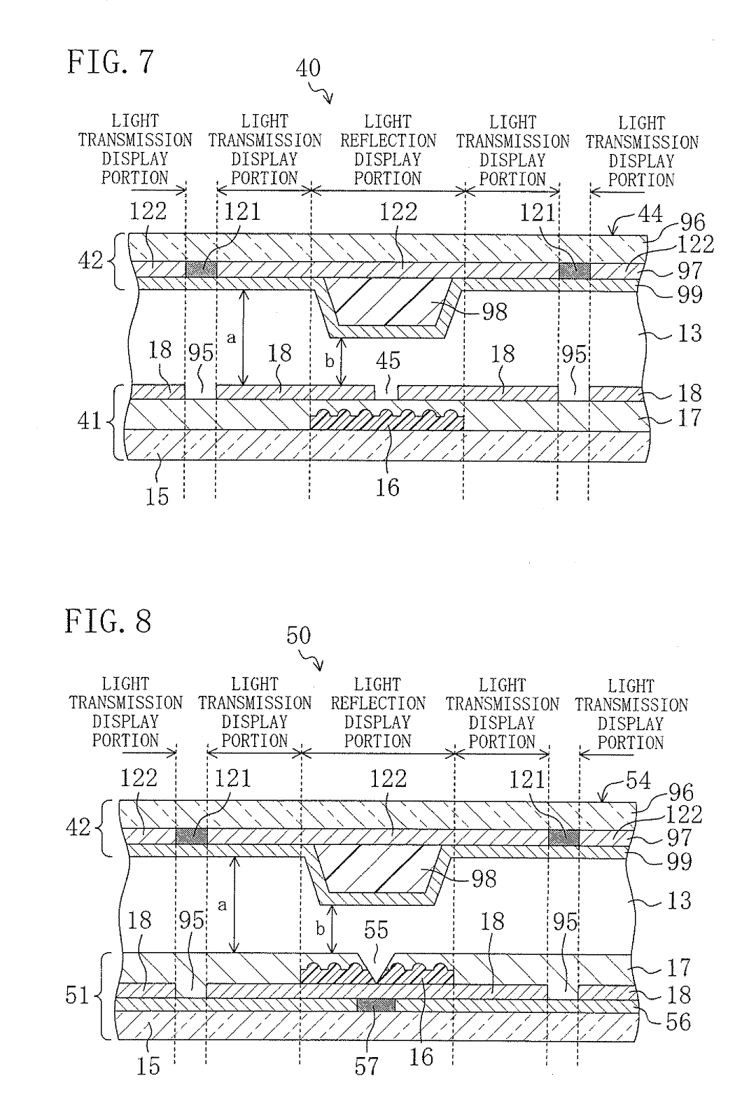

FIG. 7 shows a liquid crystal display device 40 according to a fourth embodiment. The same portions as those described in the above embodiments are denoted with the same reference numerals and characters and description thereof will be omitted.

The liquid crystal display device 40 is formed by: a liquid crystal display panel 44 having a TFT substrate 41 and a CF substrate 42 facing each other, and a liquid crystal layer 13 interposed therebetween; a not-shown backlight; and the like.

The TFT substrate 41 is formed by an insulating substrate 15, circuit elements formed on a surface of the insulating substrate 15, a reflective film 16 formed on the insulating substrate 15, a transparent insulating layer 17 formed so as to cover the reflective film 16, a pixel electrode 18 provided on the transparent insulating layer 17, and a not-shown vertical alignment film formed on the pixel electrode 18.

The pixel electrode 18 is formed on a flat surface of the transparent insulating layer 17. The pixel electrode 18 has a notch 95 formed at a predetermined position. Each pixel is divided into square pixel patterns as shown in FIG. 2 by the notch 95. The display portion 93 is defined by the pixel electrode 18. When a predetermined voltage is applied to the liquid crystal layer 13, a liquid crystal domain that provides radial tilt orientation is formed in each of the plurality of pixel patterns by orientation regulation of an oblique electric field generated around the pixel electrode 18 and near the notch 95. The pixel electrode 18 has a circular notch 45 (orientation control means) in the center of the pixel, that is, in the center of the display portion 93. The notch 45 need not necessarily have a circular shape, but may have an oval shape or a polygonal shape.

The CF substrate 42 is formed by an insulating substrate 96 made of glass or the like, a CF layer 97 formed on the insulating substrate 96, a transparent dielectric layer 98 formed on the CF layer 97, a counter electrode 99 formed on the CF layer 97 and the transparent dielectric layer 98, and a not-shown vertical alignment film formed on the counter electrode 99.

(Manufacturing Method of the Liquid Crystal Display Device 40)

Hereinafter, a method for manufacturing the liquid crystal display device 40 will be described.

(Manufacturing Method of the CF Substrate 42)

First, as in the first embodiment, an insulating substrate 96 is prepared. A black matrix 121 is formed in a region to be a light-shielding portion on the insulating substrate 96, and a color layer 122 is formed in a region to be a display portion 93 on the insulating substrate 96. A transparent dielectric layer 98 is then formed in a region to be a light reflection display portion 130 on the color layer 122. Thereafter, ITO is vapor deposited on the color layer 122, the black matrix 121, and the transparent dielectric layer 98 to form a counter electrode 99. A vertical alignment film is then formed on the counter electrode 99. The CF substrate 42 is completed by the above process.

(Manufacturing Process of the TFT Substrate 41)

Thereafter, an insulating substrate 15 is prepared, and circuit elements are provided in the same manner as in the first embodiment. Moreover, a reflective film 16 is formed in a region to be the light reflection display portion 130, and patterning is conducted. An interlayer insulating film is then formed thereon. Thereafter, ITO is vacuum deposited and patterning is conducted, whereby a pixel electrode 18 having a predetermined notch 45 is formed. The pixel electrode 18 is formed in a region to be the display portion 93.

The notch 95 for separating each pixel unit so as to define the display portion 93 and the notch 45 provided in the center of the display portion 93 as orientation control means are formed simultaneously.

Thereafter, a plurality of pillar-shaped spacers for defining the cell thickness are formed at predetermined positions outside the display portion 93 by a photolithography process.

(Process of Forming the Liquid Crystal Display Panel 44)

Thereafter, a liquid crystal display panel 44 having a liquid crystal material sealed between the two substrates is formed in the same manner as in the first embodiment, and a liquid crystal display device 40 is completed by providing a not-shown backlight unit and the like to the liquid crystal display panel 44.

### Fifth Embodiment

(Structure of a Liquid Crystal Display Device 50)

FIG. 8 shows a liquid crystal display device 50 according to a fifth embodiment. The same portions as those described in the above embodiments are denoted with the same reference numerals and characters and description thereof will be omitted.

The liquid crystal display device 50 is formed by: a liquid crystal display panel 54 having a TFT substrate 51 and a CF substrate 42 facing each other, and a liquid crystal layer 13 interposed therebetween; a not-shown backlight; and the like.

The TFT substrate 51 is formed by an insulating substrate 15, circuit elements formed on a surface of the insulating substrate 15, a transparent insulating layer 56 and a light-shielding layer 57 which are formed on the insulating substrate 15, a pixel electrode 18 provided on the transparent insulating layer 56, a reflective film 16 formed on the pixel electrode 18, a transparent insulating layer 17, and a not-shown vertical alignment film.

The transparent insulating layer 56 is formed on the insulating substrate 15 having the circuit elements formed thereon. The transparent insulating layer 56 has a circular missing part in the center of a display portion 93, and the light-shielding layer 57 is formed in this missing part. Accordingly, the light-shielding layer 57 also has a circular shape.

The light-shielding layer 57 is located right under a notch 55 (orientation control means) formed as described below at a surface of the TFT substrate 51 and serves to regulate light leakage from the notch 55 in the reflective layer. Therefore, the light-shielding layer 57 has a size equal to or larger than that of the notch 55 in the reflective layer.

The pixel electrode 18 is formed on the transparent insulating layer 56. The pixel electrode 18 has a notch 95 formed at a predetermined position. Each pixel is divided into square pixel patterns as shown in FIG. 2 by the notch 95. A display portion 93 is defined by the pixel electrode 18. When a predetermined voltage is applied to the liquid crystal layer 13, a liquid crystal domain that provides radial tilt orientation is formed in each of the plurality of pixel patterns by orientation regulation of an oblique electric field generated around the pixel electrode 18 and near the notch 95.

The reflective film 16 is formed on the center of the pixel electrode 18 and has a square shape when viewed two-dimensionally. A light reflection display portion 130 in the display portion 93 is defined by the reflective film 16. Therefore, the light reflection display portion 130 has a square shape in this embodiment. The reflective film 16 is formed by vapor depositing an Al layer or the like on a corrugated resin layer. The reflective film 16 therefore has a corrugated surface.

The transparent insulating layer 17 is formed so as to cover the reflective film 16 and thus planarizes the corrugated profile of the reflective film 16 at the surface.

A notch 55 is formed in the thickness direction in the transparent insulating film 17 and the reflective film 16 in the TFT substrate 51. The notch 55 has a cone shape having its vertex located within the reflective film 16 and its base located at the surface of the transparent insulating layer 17. The notch 55 is formed so as to be located on the center of the reflective film 16. The notch 55 need not necessarily have a cone shape, but may have a truncated cone shape, a pyramid shape, a truncated pyramid shape, or the like.

The CF substrate 42 is formed by an insulating substrate 96 made of glass or the like, a CF layer 97 formed on the insulating substrate 96, a transparent dielectric layer 98 formed on the CF layer 97, a counter electrode 99 formed on the CF layer 97 and the transparent dielectric layer 98, and a not-shown vertical alignment film formed on the counter electrode 99.

(Manufacturing Method of the Liquid Crystal Display Device 50)

Hereinafter, a method for manufacturing the liquid crystal display device 50 will be described.

(Manufacturing Method of the CF Substrate 42)

First, the CF substrate 42 is formed in the same manner as in the fourth embodiment.

(Manufacturing Process of the TFT Substrate 51)

Thereafter, an insulating substrate 15 is prepared, and circuit elements are provided in the same manner as in the first embodiment. After a transparent insulating layer 56 is formed on the insulating substrate 15, a notch 55 is formed by patterning and a light-shielding layer 57 is provided in the notch 55.

Thereafter, ITO is vacuum deposited and patterning is conducted, whereby a pixel electrode 18 having a predetermined notch 95 is formed. The pixel electrode 18 is formed in a region to be a display portion 93.

A reflective film 16 is then formed in a region to be a light reflection display portion 130 on the pixel electrode 18, and a transparent insulating layer 17 is formed to planarize the surface. A vertical alignment film is formed on the transparent insulating layer 17.

Thereafter, the vertical alignment film, the transparent insulating layer 17, and the reflective film 16 are patterned so that a conical notch 55 is located in the center of the reflection portion.

Thereafter, a plurality of pillar-shaped spacers for defining the cell thickness are formed at predetermined positions outside the display portion 93 by a photolithography process.

(Process of Forming the Liquid Crystal Display Panel 54)

Thereafter, a liquid crystal display panel 54 having a liquid crystal material sealed between the two substrates is formed in the same manner as in the first embodiment, and a liquid crystal display device 50 is completed by providing a not-shown backlight unit and the like to the liquid crystal display panel 54.

### Sixth Embodiment

(Structure of a Liquid Crystal Display Device 60)

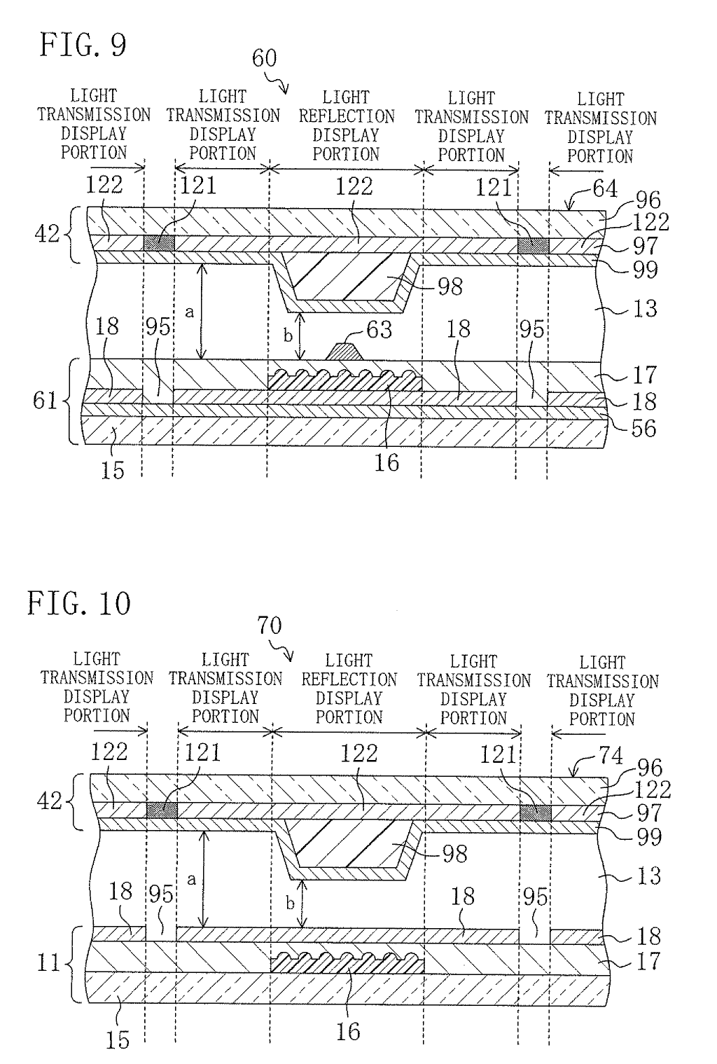

FIG. 9 shows a liquid crystal display device 60 according to a sixth embodiment. The same portions as those described in the above embodiments are denoted with the same reference numerals and characters and description thereof will be omitted.

The liquid crystal display device 60 is formed by: a liquid crystal display panel 64 having a TFT substrate 61 and a CF substrate 42 facing each other, and a liquid crystal layer 13 interposed therebetween; a not-shown backlight; and the like.

The TFT substrate 61 is formed by an insulating substrate 15, circuit elements formed on a surface of the insulating substrate 15, a transparent insulating layer 56 formed on the insulating substrate 15, a pixel electrode 18 provided on the transparent insulating layer 56, a reflective film 16 formed on the pixel electrode 18, a transparent insulating layer 17, and a not-shown vertical alignment film.

The pixel electrode 18 is formed on the transparent insulating layer 56. The pixel electrode 18 has a notch 95 formed at a predetermined position. Each pixel is divided into square pixel patterns as shown in FIG. 2 by the notch 95. A display portion 93 is defined by the pixel electrode 18. When a predetermined voltage is applied to the liquid crystal layer 13, a liquid crystal domain that provides radial tilt orientation is formed in each of the plurality of pixel patterns by orientation regulation of an oblique electric field generated around the pixel electrode 18 and near the notch 95.

The reflective film 16 is formed on the center of the pixel electrode 18 and has a square shape when viewed two-dimensionally. A light reflection display portion 130 in the display portion 93 is defined by the reflective film 16. Therefore, the light reflection display portion 130 has a square shape in this embodiment. The reflective film 16 is formed by vapor depositing an Al layer or the like on a corrugated resin layer. The reflective film 16 therefore has a corrugated surface.

The transparent insulating layer 17 is formed so as to cover the reflective film 16 and thus planarizes the corrugated profile of the reflective film 16 at the surface.

A protrusion 63 (orientation control means) is formed on the transparent insulating layer 17 and located in the center of the reflecting film 16, that is, in the center of the light reflection display portion 130. The material of the protrusion 63 is not specifically limited. The protrusion 63 may be made of a resin material, a ceramic material, or a metal material. The protrusion 63 has a truncated cone shape extending toward the opposing CF substrate 42 with a gap formed between the top of the truncated cone and the CF substrate 42. The shape of the protrusion 63 is not limited, and the protrusion 63 may have a cone shape, a pyramid shape, a truncated pyramid shape, or the like.

The CF substrate 42 is formed by an insulating substrate 96 made of glass or the like, a CF layer 97 formed on the insulating substrate 96, a transparent dielectric layer 98 formed on the CF layer 97, a counter electrode 99 formed on the CF layer 97 and the transparent dielectric layer 98, and a not-shown vertical alignment film formed on the counter electrode 99.

(Manufacturing Method of the Liquid Crystal Display Device 60)

Hereinafter, a method for manufacturing the liquid crystal display device 60 will be described.

(Manufacturing Method of the CF Substrate 42)

First, the CF substrate 42 is formed in the same manner as in the fourth embodiment.

(Manufacturing Process of the TFT Substrate 61)

Thereafter, an insulating substrate 15 is prepared, and circuit elements are provided in the same manner as in the first embodiment. A transparent insulating layer 56 is then formed on the insulating substrate 15.

Thereafter, ITO is vacuum deposited and patterning is conducted, whereby a pixel electrode 18 having a predetermined notch 95 is formed. The pixel electrode 18 is formed in a region to be a display portion 93.

A reflective film 16 is then formed in a region to be a light reflection display portion 130 on the pixel electrode 18, and a transparent insulating layer 17 is formed to planarize the surface. A vertical alignment film is formed on the transparent insulating layer 17.

Thereafter, a protrusion 63 is formed on the vertical alignment film so as to be located in the center of the light reflection display portion 130. The protrusion 63 is formed by a photolithography method.

Thereafter, a plurality of pillar-shaped spacers for defining the cell thickness are formed at predetermined positions outside the display portion 93 by a photolithography process.

(Process of Forming the Liquid Crystal Display Panel 64)

Thereafter, a liquid crystal display panel 64 having a liquid crystal material sealed between the two substrates is formed in the same manner as in the first embodiment, and a liquid crystal display device 60 is completed by providing a not-shown backlight unit and the like to the liquid crystal display panel 64.

### Seventh Embodiment

(Structure of a Liquid Crystal Display Device 70)

FIG. 10 shows a liquid crystal display device 70 according to a seventh embodiment. The same portions as those described in the above embodiments are denoted with the same reference numerals and characters and description thereof will be omitted.

The liquid crystal display device 70 is formed by: a liquid crystal display panel 74 having a TFT substrate 11 and a CF substrate 42 facing each other, and a liquid crystal layer 13 interposed therebetween; a not-shown backlight; and the like.

The TFT substrate 11 is formed by an insulating substrate 15, circuit elements formed on a surface of the insulating substrate 15, a reflective film 16 formed on the insulating substrate 15, a transparent insulating layer 17 formed so as to cover the reflective film 16, a pixel electrode 18 provided on the transparent insulating layer 17, and a not-shown vertical alignment film formed on the pixel electrode 18.

The CF substrate 42 is formed by an insulating substrate 96 made of glass or the like, a CF layer 97 formed on the insulating substrate 96, a transparent dielectric layer 98 formed on the CF layer 97, a counter electrode 99 formed on the CF layer 97 and the transparent dielectric layer 98, and a not-shown vertical alignment film formed on the counter electrode 99.

The transparent dielectric layer 98 has a truncated cone shape having a tapered side surface. The transparent dielectric layer 98 is formed in the center of a light reflection display portion 130. This transparent dielectric layer 98 serves as orientation control means.

(Manufacturing Method of the Liquid Crystal Display Device 70)

A liquid crystal display panel 74 is formed by sealing a liquid crystal material between a CF substrate 42 formed in the same manner as in the fourth embodiment and a TFT substrate 11 formed in the same manner as in the first embodiment. A liquid crystal display device 70 is completed by providing a not-shown backlight unit and the like to the liquid crystal display panel 74.

### Eighth Embodiment

(Structure of a Liquid Crystal Display Device 80)

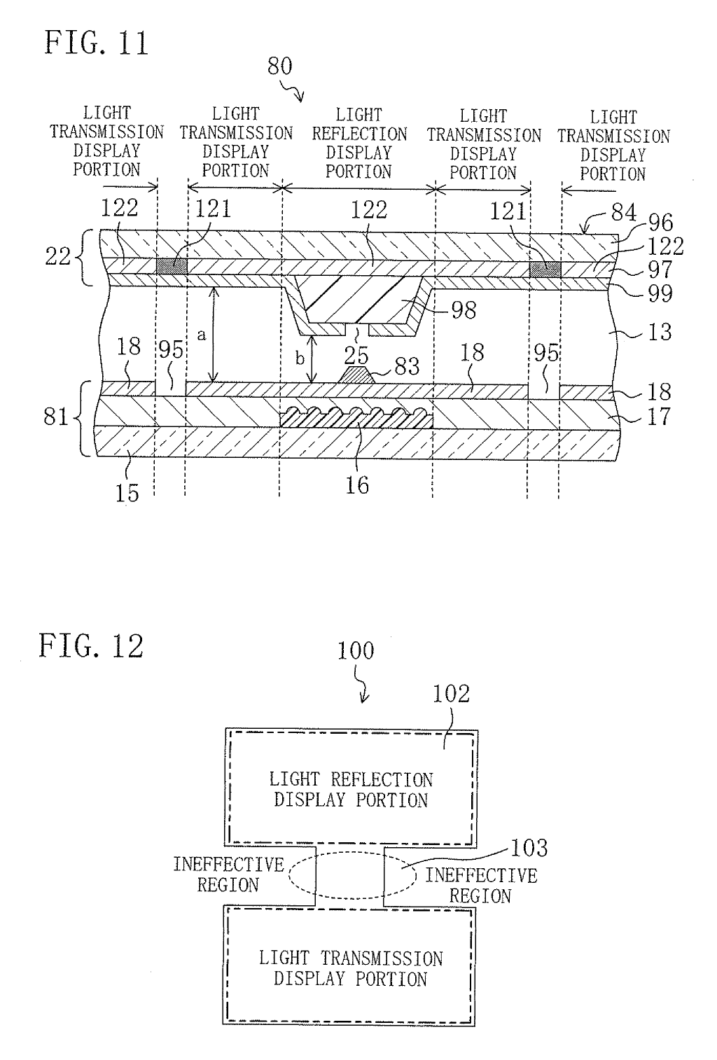

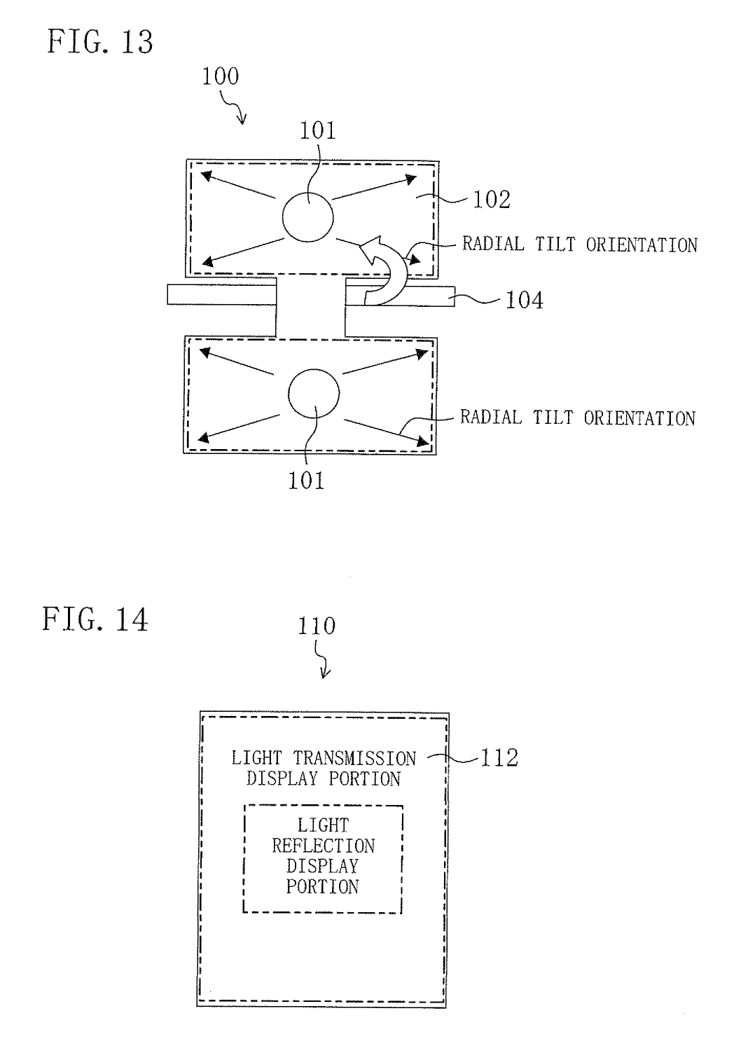

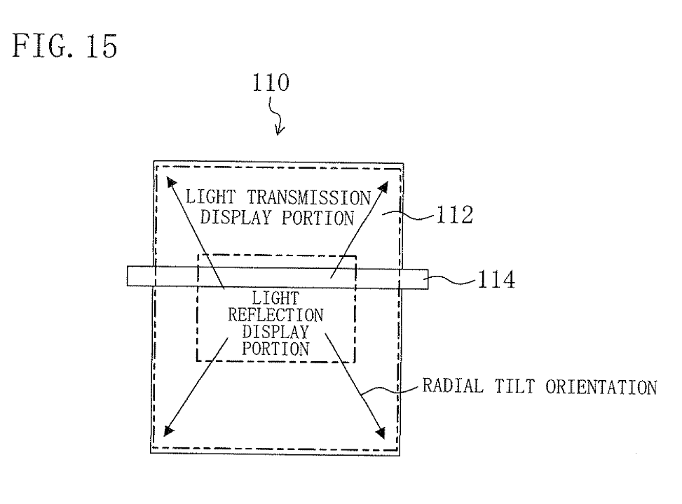

FIG. 11 shows a liquid crystal display device 80 according to an eighth embodiment. The same portions as those described in the above embodiments are denoted with the same reference numerals and characters and description thereof will be omitted.

The liquid crystal display device 80 is formed by: a liquid crystal display panel 84 having a TFT substrate 81 and a CF substrate 22 facing each other, and a liquid crystal layer 13 interposed therebetween; a not-shown backlight; and the like.

The TFT substrate 81 is formed by an insulating substrate 15, circuit elements formed on a surface of the insulating substrate 15, a reflective film 16 formed on the insulating substrate 15, a transparent insulating layer 17 formed so as to cover the reflective film 16, a pixel electrode 18 provided on the transparent insulating layer 17, a not-shown vertical alignment film formed on the pixel electrode 18, and a protrusion 83.

The protrusion 83 is formed on the center of the pixel electrode 18, that is, in the center of a light reflection display portion 130. The material of the protrusion 83 is not specifically limited. The protrusion 83 may be made of a resin material, a ceramic material, or a metal material. The protrusion 83 has a truncated cone shape extending toward the opposing CF substrate 22 with a gap formed between the top of the truncated cone and the CF substrate 22. The protrusion 83 is positioned so as to overlap a notch 25 formed on the CF substrate 22 when viewed two-dimensionally. The shape of the protrusion 83 is not limited, and the protrusion 83 may have a cone shape, a pyramid shape, a truncated pyramid shape, or the like.

In the liquid crystal display device 80, the notch 25 and the protrusion 83 are located in the center of orientation, and orientation control is conducted by both orientation control means.

Note that a liquid crystal display device having orientation control means formed on both a TFT substrate and a CF substrate as in the liquid crystal display device 80 is not limited to a liquid crystal display device in which a protrusion is formed on a TFT substrate and a notch is formed in a counter electrode of a CF substrate. In other words, a notch may be formed in a pixel electrode of a TFT substrate and a protrusion may be formed on a CF substrate.

(Manufacturing Method of the Liquid Crystal Display Device 80)

Hereinafter, a method for manufacturing the liquid crystal display device 80 will be described.

(Manufacturing Method of the CF Substrate 22)

The CF substrate 22 is formed in the same manner as in the second embodiment.

(Manufacturing Process of the TFT Substrate 81)

Thereafter, as in the first embodiment, a reflective film 16 is formed in a region to be a light reflection display portion 130 on an insulating substrate 15 having circuit elements provided thereon, and patterning is conducted. A transparent insulating layer 17 is then formed thereon. Thereafter, ITO is vacuum deposited and patterning is conducted, whereby a pixel electrode 18 having a predetermined notch 95 is formed. The pixel electrode 18 is formed in a region to be a display portion 93. A protrusion 83 is then formed in the center of the display portion 93 by patterning. Thereafter, a plurality of pillar-shaped spacers for defining the cell thickness are formed at predetermined positions outside the display portion 93 by a photolithography process.

(Process of Forming the Liquid Crystal Display Panel 84)

Thereafter, a liquid crystal display panel 84 having a liquid crystal material sealed between the two substrates is formed in the same manner as in the first embodiment, and a liquid crystal display device 80 is completed by providing a not-shown backlight unit and the like to the liquid crystal display panel 84.

In each of the above liquid crystal display devices 10 through 80, the square light reflection display portion 130 defined by the reflective film 16 is provided in the center of the square display portion 93 defined by the pixel electrode 18. Therefore, as shown in FIG. 2, the light transmission display portion 131 is positioned so as to surround the light reflection display portion 130.

In each of the above liquid crystal display devices 10 through 80, the protrusion 120, 63, 83 and the notch 25, 35, 45, 55 for providing orientation control in each pixel is formed in the center of the light reflection display portion 130. Therefore, in the case where a pixel has a light reflection display portion 130 located in the center and a light transmission display portion 131 surrounding the light reflection display portion 130 and the protrusion 120, 63, 83 and/or the notch 25, 35, 45, 55 are positioned in the center of the pixel, liquid crystal molecules of the liquid crystal layer 13 can be axisymmetrically oriented upon voltage application. Accordingly, higher contrast and a wider viewing angle of a display device can be implemented.

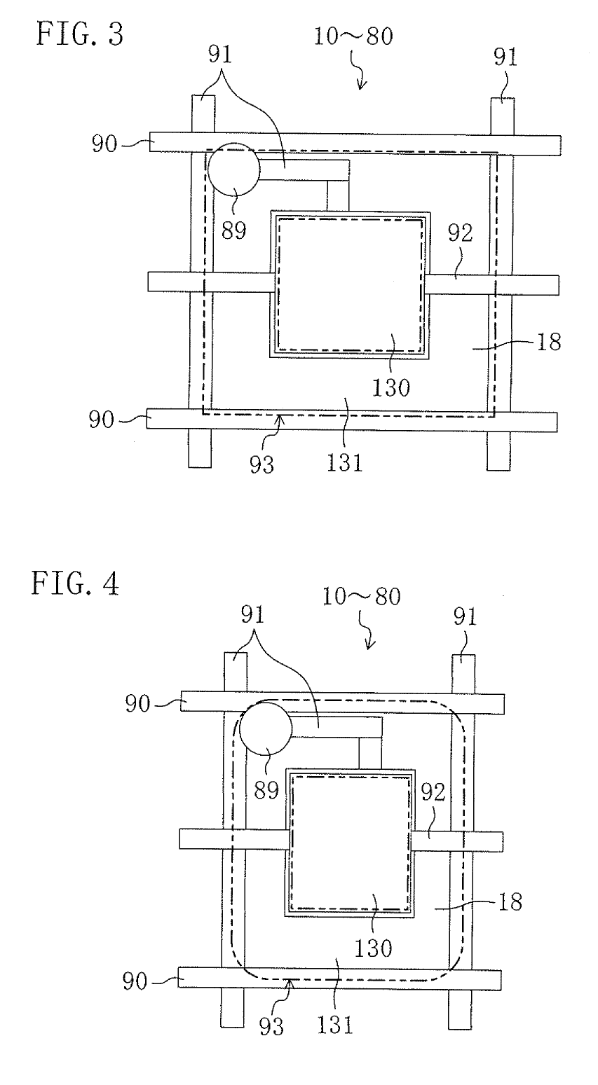

Note that the light transmission display portion 131 and the light reflection display portion 130 need not necessarily have a square shape, but may have a rectangular shape as shown in FIG. 3 or 4. In this case, however, it is preferable that the light transmission display portion 131 and the light reflection display portion 130 have a similar shape.

The light reflection display portion 130 need not necessarily be formed in the center of the light transmission display portion 131, and the protrusion 120, 63, 83 and the notch 25, 35, 45, 55 need not necessarily be formed in the center of the light reflection display portion 130.

Moreover, the respective thicknesses of the insulating substrate 96 of the CF substrate 12, 22, 32, 42 and the insulating substrate 15 of the TFT substrate 11, 41, 51, 61, 81 are not specifically limited. The insulating substrate 15 of the TFT substrate 11, 41, 51, 61, 81 may be thinner than the insulating substrate 96 of the CF substrate 12, 22, 32, 42, or both insulating substrates 15 and 96 may have the same thickness.

(Functions and Effects)

Hereinafter, functions and effects will be described.

The liquid crystal display devices 10 through 80 according to the embodiments of the invention include: a TFT substrate 11, 41, 51, 61, 81 and a CF substrate 12, 22, 32, 42 which face each other; and a liquid crystal layer 13 interposed therebetween. The liquid crystal layer 13 is made of a liquid crystal material having negative dielectric anisotropy. When no voltage is applied, liquid crystal molecules of the liquid crystal material are oriented substantially vertical to the TFT substrate 11, 41, 51, 61, 81 and the CF substrate 12, 22, 32, 42, and a display region of a liquid crystal display panel 14 through 84 is formed by a plurality of pixels. The liquid crystal display device according to the invention is characterized in that: each of the plurality of pixels includes a light reflection display portion 130 for providing display by reflecting light from a display surface side and a light transmission display portion 131 surrounding the light reflection display portion 130 for providing display by transmitting light from a back side surface; and orientation control means (a protrusion 120, 63, 83 or/and a notch 25, 35, 45, 55) for axisymmetrically orienting the liquid crystal molecules of the liquid crystal layer 13 when a voltage is applied to the liquid crystal layer 13 is provided in the light reflection display portion 130.

In this structure, each of the plurality of pixels of the liquid crystal display panel 14 through 84 has the light reflection display portion 130 and the light transmission display portion 131 surrounding the light reflection display portion 130. Therefore, the pixel electrode 18 does not have a narrowed part for providing an opening. Since there is no thinned region in the pixel electrode 18, disconnection that is conventionally caused in this region does not occur, whereby degradation in display quality can be avoided.

Moreover, it is not necessary to form an opening by providing a narrowed part in the pixel region 18. Therefore, an ineffective region that does not contribute to display is not produced in the display region. As a result, reduction in aperture ratio can be avoided.

Moreover, since the display region does not have any ineffective region where there is no pixel electrode 112, display is not affected by a potential of an underlying wiring, and abnormal display does not occur.

In the liquid crystal display devices 10 through 80 according to the embodiments of the invention, the light reflection display portion 130 may be formed in a center of the light transmission display portion 131.

In this structure, since the light reflection display portion 130 is formed in the center of the light transmission display portion 131, balanced orientation can be obtained in the entire pixel when liquid crystal molecules are oriented radially from the orientation control means. Therefore, display quality is further improved.

In the liquid crystal display devices 10 through 80 according to the embodiments of the invention, the light reflection display portion 130 and the light transmission display portion 131 may have a similar outer shape.

In this structure, since the outer shape of the light reflection display portion 130 is similar to that of the light transmission display portion 131, balanced orientation can be obtained in the entire pixel when liquid crystal molecules are oriented radially from the orientation control means (the protrusion 120, 63, 83 or/and the notch 25, 35, 45, 55). Therefore, display quality is improved.

In the liquid crystal display devices 10 through 80 according to the embodiments of the invention, the light reflection display portion 130 and the light transmission display portion 131 may have a square outer shape.

In this structure, since the light reflection display portion 130 and the light transmission display portion 131 have a square outer shape, balanced orientation of liquid crystal molecules can be obtained from the center of the light reflection display portion 130 to the end of the light transmission display portion 131. Therefore, display quality is further improved.

In the liquid crystal display devices 10 through 80 according to the embodiments of the invention, the orientation control means (the protrusion 120, 63, 83 or/and the notch 25, 35, 45, 55) may be formed in a center of the light reflection display portion 130.

In this structure, since the orientation control means (the protrusion 120, 63, 83 or/and the notch 25, 35, 45, 55) is formed in the center of the light reflection display portion 130, balanced radial orientation of liquid crystal molecules can be obtained all over around the center of the display portion 93. Therefore, display quality is improved.

In the liquid crystal display devices 10, 60, and 80 according to the embodiments of the invention, the orientation control means may be a protrusion 120, 63, 83 formed in the TFT substrate or the CF substrate.

In this structure, the protrusion 120, 63, 83 can be formed by a normal patterning process or the like. Therefore, the orientation control means can be easily formed by using existing facilities.

In the liquid crystal display devices 20, 30, 40, 50, and 80 according to the embodiments of the invention, the orientation control means may be a notch 25, 35, 45, 55 formed in the TFT substrate or the CF substrate.

In this structure, the notch 25, 35, 45, 55 can be formed by a normal patterning process or the like. Therefore, the orientation control means can be easily formed by using existing facilities.

In the liquid crystal display devices 20, 40, and 80 according to the embodiments of the invention, each of the plurality of pixels may have a pixel electrode 18 of the TFT substrate and a counter electrode 99 of the CF substrate, and the notch 25, 45 may be formed in the pixel electrode 18 or the counter electrode 99.

In this structure, the orientation control means (the notch 25, 45) can be formed simultaneously in a patterning process of the pixel electrode 18. Accordingly, manufacturing cost and manufacturing efficiency are improved.

### INDUSTRIAL APPLICABILITY

As has been described above, the invention is useful as a liquid crystal display device.

1. A liquid crystal display device, comprising: a first substrate and a second substrate which face each other; and a liquid crystal layer interposed between the first substrate and the second substrate, wherein
the liquid crystal layer is made of a liquid crystal material having negative dielectric anisotropy, and when no voltage is applied, liquid crystal molecules of the liquid crystal material are oriented substantially vertical to the first substrate and the second substrate, and a display region of a liquid crystal display panel is formed by a plurality of pixels,
each of the plurality of pixels includes a light reflection display portion for providing display by reflecting light from a display surface side and a light transmission display portion surrounding the light reflection display portion for providing display by transmitting light from a back side surface, and
orientation control means for axisymmetrically orienting the liquid crystal molecules of the liquid crystal layer when a voltage is applied to the liquid crystal layer is provided in the light reflection display portion.

2. The liquid crystal display device according to claim 1, wherein the light reflection display portion is formed in a center of the light transmission display portion.

3. The liquid crystal display device according to claim 1, wherein the light reflection display portion and the light transmission display portion have a similar outer shape.

4. The liquid crystal display device according to claim 3, wherein the light reflection display portion and the light transmission display portion have a square outer shape.

5. The liquid crystal display device according to claim 1, wherein the orientation control means is formed in a center of the light reflection display portion.

6. The liquid crystal display device according to claim 1, wherein the orientation control means is a protrusion formed in the first substrate or the second substrate.

7. The liquid crystal display device according to claim 1, wherein the orientation control means is a notch formed in the first substrate or the second substrate.

8. The liquid crystal display device according to claim 7, wherein each of the plurality of pixels has a first electrode of the first substrate and a second electrode of the second substrate, and the notch is formed in the first electrode or the second electrode.
